(19) United States
(12) Patent Application Publication
(10) Pub. No.: US 2018/0253985 A1
(43) Pub. Date: Sep. 6, 2018

(54) GENERATING MESSAGING STREAMS

(71) Applicant: Aspiring Minds Assessment Private Limited, New Delhi (IN)

(72) Inventors: Varun AGGARWAL, Gurgaon (IN); Vishal VENUGOPAL, Gurgaon (IN)

(21) Appl. No.: 15/910,955

(22) Filed: Mar. 2, 2018

(30) Foreign Application Priority Data
Mar. 2, 2017 (IN) 201711007340

(51) Int. Cl. G09B 5/02; H04L 29/08; H04L 12/58; G06N 99/00

(52) U.S. Cl. CPC G09B 5/02; H04L 67/306; G06F 3/04842; G06N 99/005; H04L 51/02

(57) ABSTRACT

A method for generating a messaging stream that is transmitted over a network to a user device is disclosed. The method includes generating an introductory message. The method further includes receiving an introductory response from the user device. The method further includes providing a first module question to the user device. The method further includes determining whether a first module response that includes one or more words received from the user corresponds to one of a set of recognizable responses stored in a database. The method further includes scoring the first module responses. The method further includes generating a user interface that includes a score of the user responses.

### CROSS REFERENCE TO RELATED APPLICATIONS

This application claims the benefit of Indian Provisional Patent Application No. 201711007340, entitled “Chat System for Assessment of Skills,” filed Mar. 2, 2017, which is incorporated by reference in its entirety.

### BACKGROUND

Automated messaging applications are increasingly used for communication with users. Automated messaging applications may be used to obtain information from a user and/or provide a user with useful services. However, people with different levels of familiarity to technology may have different reactions to messages generated by an automated messaging application. For example, for some users, if the automated messaging application is overly technical, the users may not use the application because it seems too complicated. Conversely, for some users, if the automated messaging application is too informal, the users may not take it seriously. As a result, user engagement with the automated messaging application may fail.

Previous techniques for obtaining information from users may suffer from low user engagement. For example, users are less likely to respond to a series of questions provided on a website. As a result, previous techniques have low user engagement and, as a result, fail to get the needed information from users.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Embodiments generally relate to a computer-implemented method to generate a messaging stream that is transmitted over a network to a user device is disclosed. The method includes generating an introductory message. The method further includes receiving an introductory response from the user device. The method further includes scoring the first module responses and generating a user interface that includes one or more scores for the first module responses. The method further includes providing a first module question to the user device. The method further includes determining whether a first module response that includes one or more words received from the user corresponds to one of a set of recognizable responses stored in a database. Where, responsive to one or more of the introductory response, the authentication response, and the first module response being identified as an unrecognizable response, providing a clarification request.

In some embodiments, the method further includes determining a user preference for a type of communication based on one or more of the introductory response, the authentication response, and the first module responses and configuring the first module questions based on the user preference for the type of communication. In some embodiments, the unrecognizable response is identified by using machine-learning model that is trained to categorize user responses as one of the recognizable responses or the unrecognizable response, wherein the machine-learning model is trained on prior user responses. In some embodiments, the method further includes receiving feedback to reclassify a first module response that was classified as the unrecognizable response to be one of the recognizable responses and modifying the recognizable responses based on the feedback. In some embodiments, the method further includes providing an authentication message to the user device that requests authentication information in order to identify a user profile that corresponds to a user associated with the user device. The method further includes determining, based on an authentication response from the user device, that the user provided the authentication information for the user profile. In some embodiments, the first module questions correspond to a test and the user interface further includes recommendations about areas of improvement that are designed to help the user improve performance on the test. In some embodiments, the set of recognizable responses and actions based on the set of recognizable responses in the database are organized as a tree structure. In some embodiments, the method further comprises receiving a request from the user to exit the first module and responsive to receiving the request, providing second module questions to the user.

The embodiments provided herein advantageously determine a user preference for a type of communication to be presented by a messaging application. As a result of using the user preference for the type of communication, the messaging application increases user engagement and results in obtaining more information from the user, following up with the user if the user fails to respond for a certain amount of time, and providing helpful menus to navigate. In addition, the messaging application uses a database to efficiently compare user responses to identifiable information and junk data to determine whether the user responses are identifiable information. The messaging application advantageously uses machine learning to improve the process and refines the process of determining whether the user responses are identifiable information based on receiving feedback.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 illustrates a block diagram of an example system that generates a messaging stream for obtaining user information according to some embodiments.

FIG. 2 illustrates a block diagram of an example computing device that generates a messaging stream for obtaining user information according to some embodiments.

FIG. 3A illustrates an example user interface of a messaging stream for an introduction sequence that includes an informal communication style according to some embodiments.

FIG. 3B illustrates an example user interface of a messaging stream for an introduction sequence that includes a formal communication style according to some embodiments.

FIG. 3C illustrates an example user interface of a messaging stream for an authentication sequence according to some embodiments.

FIG. 3D illustrates an example user interface of a messaging stream for a disclaimer sequence according to some embodiments.

FIG. 3E illustrates an example user interface of a messaging stream for answering test questions for a first module according to some embodiments.

FIG. 3F illustrates an example user interface of a messaging stream with helpful commands according to some embodiments.

FIG. 3G illustrates an example user interface of a messaging stream for pausing the test according to some embodiments.

FIG. 3H illustrates an example user interface of a messaging stream for skipping a question according to some embodiments.

FIG. 3I illustrates an example user interface for moving to a next module according to some embodiments.

FIG. 3J illustrates an example user interface of a messaging stream for quitting a test according to some embodiments.

FIG. 3K illustrates an example user interface of a messaging stream that includes scores and recommendations about areas of improvement according to some embodiments.

FIG. 4 illustrates a flowchart of an example overview method of interactions between the messaging application and a user device according to some embodiments.

FIG. 5 illustrates a flowchart of an example method for an authentication sequence according to some embodiments.

FIG. 6 illustrates a flowchart of an example method for a disclaimer sequence according to some embodiments.

FIG. 7 illustrates a flowchart of an example method for a user registration sequence according to some embodiments.

FIG. 8 illustrates a flowchart of an example method for a security questions sequence according to some embodiments.

FIGS. 9A-B illustrates a flowchart of an example method for a questions sequence according to some embodiments.

FIG. 10 illustrates a flowchart of an example method for unrecognizable responses sequence according to some embodiments.

FIG. 11 illustrates a flowchart of an example method for a no response sequence according to some embodiments.

FIG. 12 illustrates a flowchart of an example method for generating a messaging stream according to some embodiments.

### DETAILED DESCRIPTION

### Example System

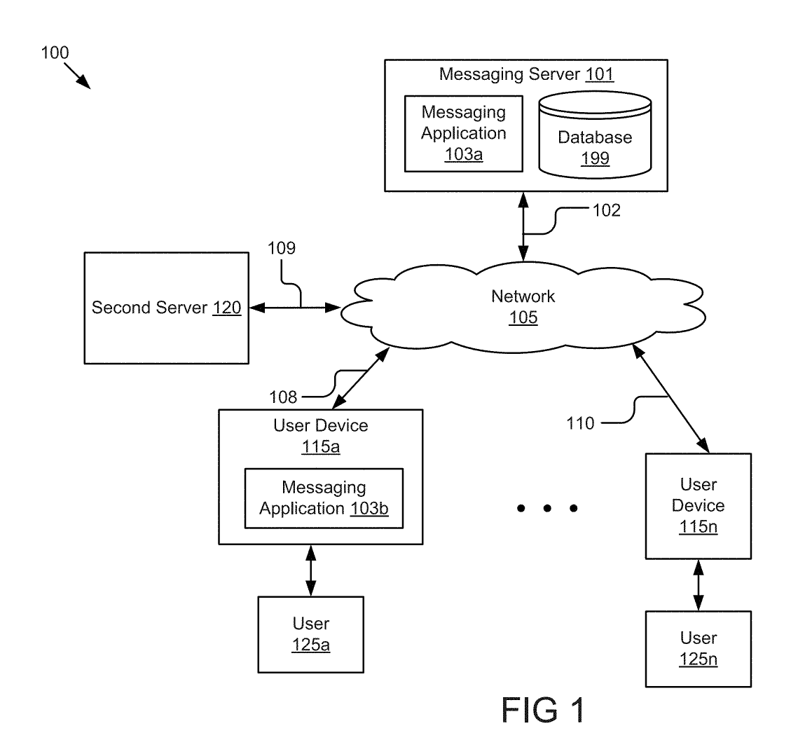

FIG. 1 illustrates a block diagram of an example system 100 that generates a messaging stream. The illustrated system 100 includes a messaging server 101, user devices 115a, 115n, a second server 120, and a network 105. Users 125a, 125n may be associated with respective user devices 115a, 115n. In some embodiments, the system 100 may include other servers or devices not shown in FIG. 1. In FIG. 1 and the remaining figures, a letter after a reference number, e.g., “115a,” represents a reference to the element having that particular reference number. A reference number in the text without a following letter, e.g., “115,” represents a general reference to embodiments of the element bearing that reference number.

The messaging server 101 may include a processor, a memory, and network communication capabilities. In some embodiments, the messaging server 101 is a hardware server. The messaging server 101 is communicatively coupled to the network 105 via signal line 102. Signal line 102 may be a wired connection, such as Ethernet, coaxial cable, fiber-optic cable, etc., or a wireless connection, such as Wi-Fi®, Bluetooth®, or other wireless technology. In some embodiments, the messaging server 101 sends and receives data to and from one or more of the user devices 115a, 115n and the second server 120 via the network 105. The messaging server 101 may include a messaging application 103a and a database 199.

The messaging application 103a may be code and routines operable to generate a messaging stream. The messaging application 103 may be a chat bot that uses a machine-learning module to automatically respond to user responses. The messaging application 103 may be used to obtain user information. For example, the messaging application 103 may be a chat bot that provides a test to a user, receives user responses, scores the responses, and provides a test score to the user. In some embodiments, the messaging application 103a may be implemented using hardware including a field-programmable gate array (FPGA) or an application-specific integrated circuit (ASIC). In some embodiments, the messaging application 103a may be implemented using a combination of hardware and software.

The database 199 may information related to the operation of the messaging application 103. For example, the database 199 may store chatbot instructions (e.g., the information used to interpret user responses and to parse and create messages for the user), user and test configurations, questions, etc. In some examples, the database 199 may store messages between a user and the messaging application 103. The database 199 may also store social network data associated with users 125, user preferences for the users 125, etc. In some embodiments, the database 199 includes a separate database for the chatbot instructions, a separate database for the user and test configurations, and a separate database for the questions.

The user device 115 may be a computing device that includes a memory and a hardware processor. For example, the user device may include a desktop computer, a mobile device, a tablet computer, a mobile telephone, a wearable device, a mobile device, a portable game player, a portable music player, a reader device, or another electronic device capable of accessing a network 105.

In the illustrated implementation, user device 115a is coupled to the network 105 via signal line 108 and user device 115n is coupled to the network 105 via signal line 110. Signal lines 108 and 110 may be a wired connection, such as Ethernet, coaxial cable, fiber-optic cable, etc., or a wireless connection, such as Wi-Fi®, Bluetooth®, or other wireless technology. User devices 115a, 115n are accessed by users 125a, 125n, respectively. The user devices 115a, 115n in FIG. 1 are used by way of example. While FIG. 1 illustrates two user devices, 115a and 115n, the disclosure applies to a system architecture having one or more user devices 115.

In some embodiments, messaging application 103b may be stored on a user device 115a. The messaging application 103 may include a thin-client messaging application 103b stored on the user device 115a and a messaging application 103a that is stored on the messaging server 101. For example, the messaging application 103b stored on the user device 115a may display a messaging stream. The user device 115a may receiver user input, such as an answer to a question. The user device 115a may transmit the user response to the messaging application 103a stored on the messaging server 101.

The second server 120 may include a processor, a memory, and network communication capabilities. The second server 120 may access the network 105 via signal line 109. The second server 120 may receive information from the messaging application 103 about the messaging stream and provide information to the messaging application 103. For example, the second server 120 may include a social networking application that receives information from the messaging application 103a, displays a messaging stream to the user device 115, and receives user responses from the user device 115 that the social networking application sends back to the messaging application 103. The second server 120 may include software for providing any type of chat interface, such as the chat interfaces in Facebook, Google Hangouts, Whatsapp, etc.

In the illustrated implementation, the entities of the system 100 are communicatively coupled via a network 105. The network 105 may be a conventional type, wired or wireless, and may have numerous different configurations including a star configuration, token ring configuration or other configurations. Furthermore, the network 105 may include a local area network (LAN), a wide area network (WAN) (e.g., the Internet), and/or other interconnected data paths across which multiple devices may communicate. In some embodiments, the network 105 may be a peer-to-peer network. The network 105 may also be coupled to or include portions of a telecommunications network for sending data in a variety of different communication protocols. In some embodiments, the network 105 includes Bluetooth® communication networks, WiFi®, or a cellular communications network for sending and receiving data including via short messaging service (SMS), multimedia messaging service (MMS), hypertext transfer protocol (HTTP), direct data connection, email, etc. Although FIG. 1 illustrates one network 105 coupled to the user devices 115 and the messaging server 101, in practice one or more networks 105 may be coupled to these entities.

### Example Computing Device

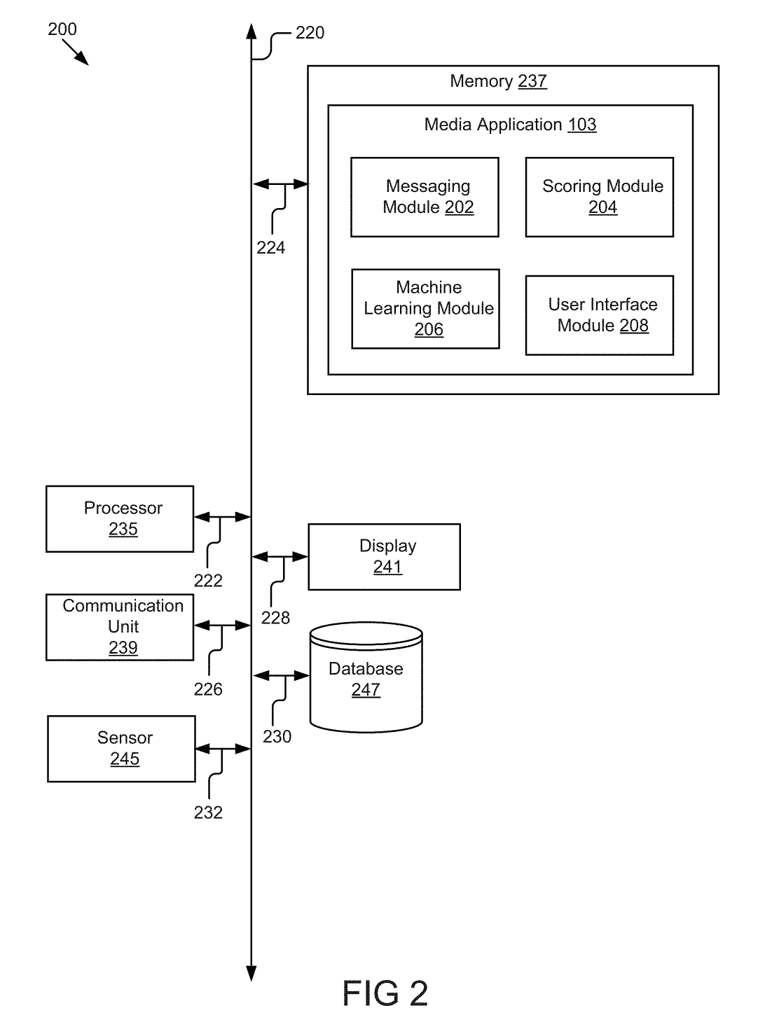

FIG. 2 illustrates a block diagram of an example computing device 200 that generates a messaging stream. The computing device 200 may be a messaging server 101 or a user device 115. The computing device 200 may include a processor 235, a memory 237, a communication unit 239, a display 241, and a database 247. Additional components may be present or some of the previous components may be omitted depending on the type of computing device 200. For example, if the computing device 200 is the messaging server 101, the computing device 200 may not include the display 241. A messaging application 103 may be stored in the memory 237. In some embodiments, the computing device 200 may include other components not listed here, such as a battery, etc. The components of the computing device 200 may be communicatively coupled by a bus 220.

The processor 235 includes an arithmetic logic unit, a microprocessor, a general purpose controller or some other processor array to perform computations and provide instructions to a display device. Processor 235 processes data and may include various computing architectures including a complex instruction set computer (CISC) architecture, a reduced instruction set computer (RISC) architecture, or an architecture implementing a combination of instruction sets. Although FIG. 2 includes a single processor 235, multiple processors 235 may be included. Other processors, operating systems, sensors, displays and physical configurations may be part of the computing device 200. The processor 235 is coupled to the bus 220 for communication with the other components via signal line 222.

The memory 237 stores instructions that may be executed by the processor 235 and/or data. The instructions may include code for performing the techniques described herein. The memory 237 may be a dynamic random access memory (DRAM) device, a static RAM, or some other memory device. In some embodiments, the memory 237 also includes a non-volatile memory, such as a (SRAM) device or flash memory, or similar permanent storage device and media including a hard disk drive, a compact disc read only memory (CD-ROM) device, a DVD-ROM device, a DVD-RAM device, a DVD-RW device, a flash memory device, or some other mass storage device for storing information on a more permanent basis. The memory 237 includes code and routines operable to execute the messaging application 103, which is described in greater detail below. The memory 237 is coupled to the bus 220 for communication with the other components via signal line 224.

The communication unit 239 transmits and receives data to and from at least one of the user device 115 and the messaging server 101 depending upon where the messaging application 103 may be stored. In some embodiments, the communication unit 239 includes a port for direct physical connection to the network 105 or to another communication channel. For example, the communication unit 239 includes a universal serial bus (USB), secure digital (SD), category 5 cable (CAT-5) or similar port for wired communication with the user device 115 or the messaging server 101, depending on where the messaging application 103 may be stored. In some embodiments, the communication unit 239 includes a wireless transceiver for exchanging data with the user device 115, messaging server 101, or other communication channels using one or more wireless communication methods, including IEEE 802.11, IEEE 802.16, Bluetooth® or another suitable wireless communication method. The communication unit 239 is coupled to the bus 220 for communication with the other components via signal line 226.

In some embodiments, the communication unit 239 includes a cellular communications transceiver for sending and receiving data over a cellular communications network including via short messaging service (SMS), multimedia messaging service (MMS), hypertext transfer protocol (HTTP), direct data connection, e-mail or another suitable type of electronic communication. In some embodiments, the communication unit 239 includes a wired port and a wireless transceiver. The communication unit 239 also provides other conventional connections to the network 105 for distribution of files and/or media objects using standard network protocols including, but not limited to, user datagram protocol (UDP), TCP/IP, HTTP, HTTP secure (HTTPS), simple mail transfer protocol (SMTP), SPDY, quick UDP internet connections (QUIC), etc.

The display 241 may include hardware operable to display graphical data received from the messaging application 103. For example, the display 241 may render graphics to display a messaging stream. The display 241 is coupled to the bus 220 for communication with the other components via signal line 228.

The database 247 may be a non-transitory computer-readable storage medium that stores data that provides the functionality described herein. In embodiments where the computing device 200 is the messaging server 101, the database 247 may include the database 199 in FIG. 1. The database 247 may be a DRAM device, a SRAM device, flash memory or some other memory device. In some embodiments, the database 247 also includes a non-volatile memory or similar permanent storage device and media including a hard disk drive, a CD-ROM device, a DVD-ROM device, a DVD-RAM device, a DVD-RW device, a flash memory device, or some other mass storage device for storing information on a permanent basis. The database 247 is coupled to the bus 220 for communication with the other components via signal line 230.

The messaging application 103 may include a messaging module 202, a scoring module 204, a machine learning module 206, and a user interface module 208.

The messaging module 202 generates a messaging stream. In some embodiments, the messaging module 202 includes a set of instructions executable by the processor 235 to generate the messaging stream. In some embodiments, the messaging module 202 is stored in the memory 237 of the computing device 200 and can be accessible and executable by the processor 235.

In some embodiments, the messaging module 202 generates a messaging stream that includes data sent to and from users, for example, by sending data to a user device 115, a messaging server 101, and/or a second server 120. The messaging stream may include one or more messages where the messages have certain characteristics, such as a sender; a recipient; and message content including text, emojis, images, audio, video, and message metadata. For example, the messages may be played as audio or displayed as videos. The message metadata may include a timestamp, an originating device identifier, an expiration time, a retention time, various formats and effects applied, etc. In some embodiments, the messaging stream includes a displayed messaging stream that includes messages displayed in chronological order within a user interface with various formats and effects applied. In some embodiments, messages are delivered in the order they are sent. Because large text may be broken into parts, a single message may be transmitted as multiple messages that are then displayed as multiple messages in the order that they are delivered and sent.

The messaging stream may be used as part of different messaging platforms, such as part of an instant messaging application, a short-message service (SMS), an email application, an enhanced-message service (EMS), a multimedia-message service (MMS), push messaging (e.g., HDML, WAP push, etc.), application-to-application messaging, etc. The messages may be available for a limited amount of time, archived for an indeterminate time, etc. The messages may be encrypted.

The messaging module 202 may generate messages that correspond to different sequences. For example, the messaging module 202 may provide messages for one or more of the following sequences: an introduction sequence, an authentication sequence, a disclaimer sequence, a user registration sequence, a security question sequence, a question answering sequence, an unrecognizable response sequence, a no response sequence, and an exit sequence. Some of these sequences are described below with reference to the flowcharts. In some embodiments, the messaging module 202 generates messages for each of the sequences by retrieving a corresponding message from the database 247. For example, for the introduction, the messaging module 202 may generate an introduction message.

In some embodiments, the messaging module 202 uses the sequences to administer a test. The test may be timed or unlimited. The messaging module 202 may allow a user to switch between question modules or allow a user to advance to a subsequent module, but prohibit the user from moving to a previous module. The messaging module 202 may provide an option to exist the test and come back later to restart the test.

In some embodiments, the messaging module 202 includes multiple units that perform different functions. For example, the messaging module 202 may include a question delivery unit, a user response unit, an answer checking unit, and a question choice unit. The question delivery unit may automatically post questions with or without answer options to the messaging stream. Once the user provides user responses, the user response unit may retrieve the user responses and provide it to the answer checking unit, which compares the user responses with correct answers and scores the user responses.

In some embodiments, the answer checking unit scores the user responses based on whether the answer is the correct answer. In some embodiments, the answer checking unit scores the user response based on a range of multiple choice answers, such as best answer, second best answer, third best answer, and wrong answer. In some embodiments, where the user responses include a natural language response, the answer checking unit scores the user response based on comparing the natural language response to a model answer. In some embodiments, the answer checking unit scores user responses based on both an accuracy of the answer and a confidence associated with the answer. For example, the answer checking unit may score “Answer is C” as 4 marks because it is correct and expresses complete confidence, “Maybe the answer is CT” as 2 marks because it is correct but not confident, “I guess it is C” as 2 marks because it is correct but not confident, and “I think it is B or C” as 1 mark because it has a correct answer but also a wrong answer and is not confident. The answer checking unit may score user responses based on a confidence associated with the answer using the machine-learning model described below with reference to the machine learning module 206. The answer checking unit may send the scores to the scoring module 204, which aggregates each of the scores and generates an overall score for a test taken by the user.

The question choice unit selects a new question for the question delivery unit to post. In some embodiments, the new question is based on the score for a previous user response. For example, the question choice unit may select increasingly more difficult questions if the user continues to get high scores for previous questions and/or based on a confidence expressed in the user response. For example, the question choice unit may select increasingly more difficult questions if the user responses are expressed confidently. Conversely, the question choice unit may select an easier question if the user received a low score for a previous question and/or the user response includes a low confidence, such as adding a “?” at the end of the user response or weaker language, such as “I think the answer is B.” The selection of questions may be based on item response theory (IRT) and concepts of adaptive testing, such as exposure control, maximum information criteria, content balancing, etc. In other examples, the question choice unit may select a subsequent question until there are no more questions left.

When the user responds to a message provided in the messaging stream, the messaging module 202 may compare a user response that includes one or more words to recognizable responses that are stored in the database 247 to determine whether the user response corresponds to any of the recognizable responses. The recognizable responses may be identified by the machine learning module 206, which is discussed in greater detail below. If the user response does not correspond to any of the recognizable responses, the messaging module 202 may determine that the user response is unrecognizable and, as a result, initiate the unrecognizable response sequence.

In some embodiments, the messaging module 202 determines a user preference for a type of communication and configures the messages based on the type of communication. In some embodiments, the messaging module 202 provides a standard introductory message to all users and determines the user preference based on an introductory response. For example, the messaging module 202 may provide an informal introductory message with silly emojis, no capitalization, no periods, and/or informal spelling such as “u” instead of “you.” If the introductory response from the user is written to be similarly informal, the messaging module 202 may determine that the user preference is for an informal type of communication. Conversely, if the introductory response from the user is written to be formal, for example, because the response uses complete sentences with capitalization, proper punctuation, and no abbreviations, the messaging module 202 may determine that the user preference is for a formal type of communication.

In some embodiments, the messaging module 202 instructs the user interface module 208 to generate a user interface that includes the messaging stream. The user interface may include fields for the user to provide user responses in the form of text, videos, images, emojis, etc. In some embodiments, the message is transmitted from the user device 115 to the messaging server 101.

In some embodiments, the messaging module 202 instructs the user interface module 208 to generate a user interface that includes graphical elements, such as buttons, for a user to select. If the user selects one of the buttons, it may cause the user interface to automatically generate a text response on behalf of the user that corresponds to the text associated with the selected button.

In some embodiments, the messaging module 202 may receive user responses in different formats via the user interface. For example, the messaging module 202 may receive text user responses as described above. In another example, the messaging module 202 may receive spoken word user responses that it translates to text.

The scoring module 204 generates a score based on user responses. In some embodiments, the scoring learning module 204 includes a set of instructions executable by the processor 235 to generate the score. In some embodiments, the scoring module 204 is stored in the memory 237 of the computing device 200 and can be accessible and executable by the processor 235.

In some embodiments, the scoring module 204 receives a score for each user response to a question from the messaging module 202. For example, the messaging module 202 includes an answer checking unit that provides the individual scores. In some embodiments, each user response may be scored the same, weighted based on a type of module, weighted based on a difficulty of the answer, etc. The questions may be scored based on item response theory, and the scores may be combined based on IRT. In some embodiments, the scoring module 204 may also adjust the score based on other factors, such as whether the user completed the test in the allotted time, completed the test faster than the allotted time, paused the test, etc. For example, the scoring module 204 may detect 5 points for each time the user paused the test.

The scoring module 204 may instruct the user interface module 208 to provide the user with a score. In some embodiments, the scoring module 204 may also generate recommendations about areas of improvement. The recommendations about areas of improvement may be designed to help the user improve performance on the test. For example, if the test is preparation for the law school admissions test (LSAT), the recommendations may indicate that the user is weak in logical reasoning but is strong in analytical reasoning.

In some embodiments, the scoring module 204 maintains a record of the user's scores. For example, the messaging module 204 may generate a user profile that includes the user name, password, security questions, confirmations of disclaimers, etc. The messaging module 204 may update the user profile with information about all tests taken by the user. The scoring module 204 may add to the test-taking information all instances where a user answered a question, the accuracy of the score, an overall score for the user, etc. The scoring module 204 may determine areas of improvement for the user and instruct the user interface module 208 to provide recommendations to the user about areas of improvement. In some embodiments, the scoring module 204 may recommend that the user take additional questions specific to the area that needs improvement. The scoring module 204 may also recommend additional resources for improving scores, such as a third-party website for personal tutoring.

The machine learning module 206 generates a machine-learning model. In some embodiments, the machine learning module 206 includes a set of instructions executable by the processor 235 to generate the machine-learning module. In some embodiments, the machine learning module 206 is stored in the memory 237 of the computing device 200 and can be accessible and executable by the processor 235.

In some embodiments, the machine learning module 206 generates a machine-learning model to determine the best way to present messages to the user. For example, the machine learning module 206 may determine that the order of the different sequences should be an introduction, authentication, a disclaimer, user registration, security question establishment, question answering, unrecognizable response, no response, and exit. More specifically, the machine learning module 206 may determine that users are more likely to engage with the messaging application 103 if the end of the instruction sequence includes a question about whether to start a test for the user as opposed to asking whether to start a test for the user after the user has completed authentication, affirmed the disclaimer, completed registration, and established security questions.

In some embodiments, the machine learning module 206 generates a machine-learning module that is trained to categorize user responses that include words as a recognizable response or an unrecognizable response. The machine-learning model may be trained to determine the intent of the user based on the user responses. The machine-learning model may be trained based on prior user responses. For example, the machine learning module 206 may recognize that when the messaging module 202 asks a user for their password, any response with “my password is *,” “password is *,” “it is *,” or “*” count as recognizable responses that include the user's password.

The machine learning module 206 may identify an unrecognizable response based on the machine-learning module, for example, by determining that the user response does not correspond to one of the recognizable responses. In some embodiments, the machine learning module 206 may categorize the unrecognizable response as a known response and then determine an action based on it. For example, if the messaging module 202 asks the user for a password and the user responds “p:*” the messaging module 202 may determine that “p:” is meant to correspond to password and that the password is “*.”

The machine learning module 206 may revise the machine-learning module based on receiving feedback. For example, the machine-learning module 206 may receive feedback to reclassify a user response that was classified as an unrecognizable response to be a recognizable response. For example, the administrator may indicate that “pwd is *” is an acceptable response to a request for a password because “pwd” is shorthand for password. In some embodiments, the machine learning module 206 reclassifies a user response based on subsequent interactions. For example, the messaging module 202 asks the user for a password and the user responses with “pwd is *.” The messaging module 202 may determine that “pwd is *” is an unrecognizable response and respond with, “I did not understand that. Can you please provide your password?” If the user responds with another term that is a recognizable response, such as “password is *,” the machine-learning module 206 may determine that the user's previous response also included a recognizable response.

In some embodiments, the machine learning module 206 generates a machine-learning model to determine how to score the user responses. For example, the machine-learning model may be used to determine how close the user response is to a model answer. This may be particularly valuable when the user responses are in the form of a natural language response. The machine-learning model may also be used to determine how to score a user response that includes an expression of confidence. For example, the machine-learning module may determine that “Answer is C” is most confident and that it should receive a higher score than “Maybe the answer is CT” In some embodiments where the messaging module 202 determines that the user response is unrecognizable, the machine-learning model may score the user response based on the unrecognizable response. For example, the machine-learning model may determine that the user response is not remotely close to the answer and score the user response as being wrong. Conversely, the machine-learning model may determine that the user response is somewhat similar to the correct answer and score the user response accordingly.

The user interface module 208 generates a user interface. In some embodiments, the user interface module 208 includes a set of instructions executable by the processor 235 to generate the user interface. In some embodiments, the user interface module 208 is stored in the memory 237 of the computing device 200 and can be accessible and executable by the processor 235.

The machine learning module 206 may generate the machine-learning model using one or more of a machine-learning approach, an expert-driven approach, and a rule-based technique. The machine-learning approach may include, but may not be limited to, a linear regression, a generalized linear regression, a ridge regression, bagging, boosting, genetic programming, a forward selection, a backward selection, a decision tree, or a random forest. The expert-driven approach involves a domain expert deciding which features should be used for a problem and how to use them. The selection of the one or more features in the expert-driven approach includes, but may not be limited to, selecting features that were extracted, observed from, and/or in a training set.

In some embodiments, the user interface module 208 receives instructions from the messaging module 202 to generate a user interface that includes a messaging stream. For example, the messaging module 202 may instruct the user interface module 208 to generate graphical data that is rendered on the user device 115 as a user interface. The user interface may include a messaging stream and messages that occur between the messaging module 202 and the user.

### Example User Interfaces

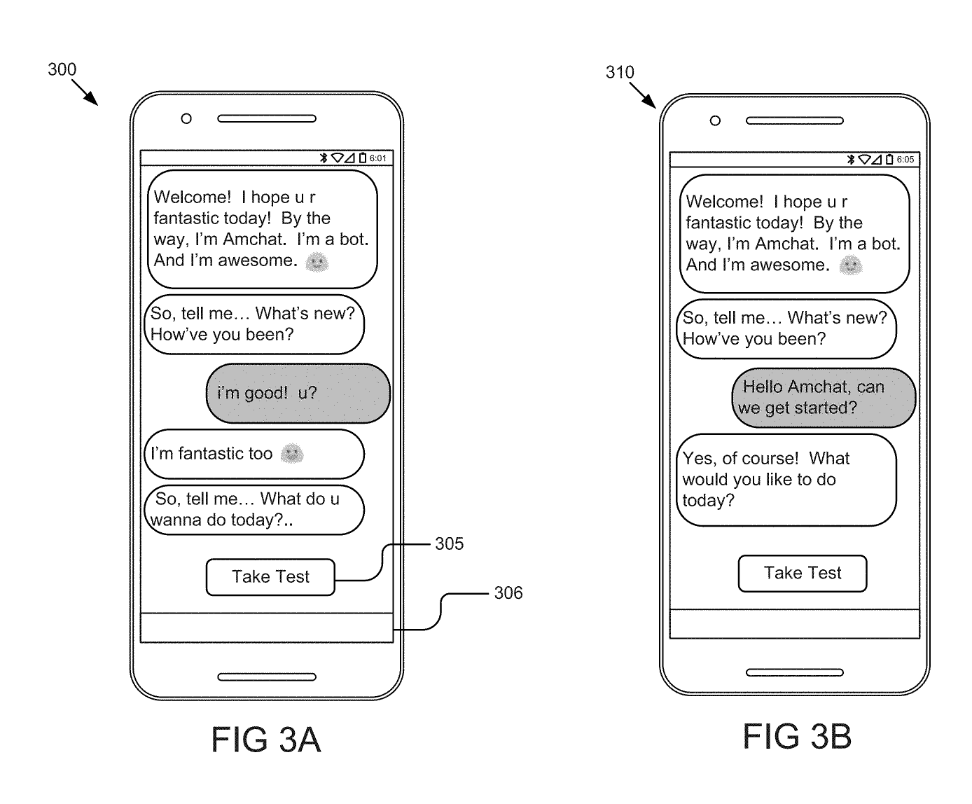

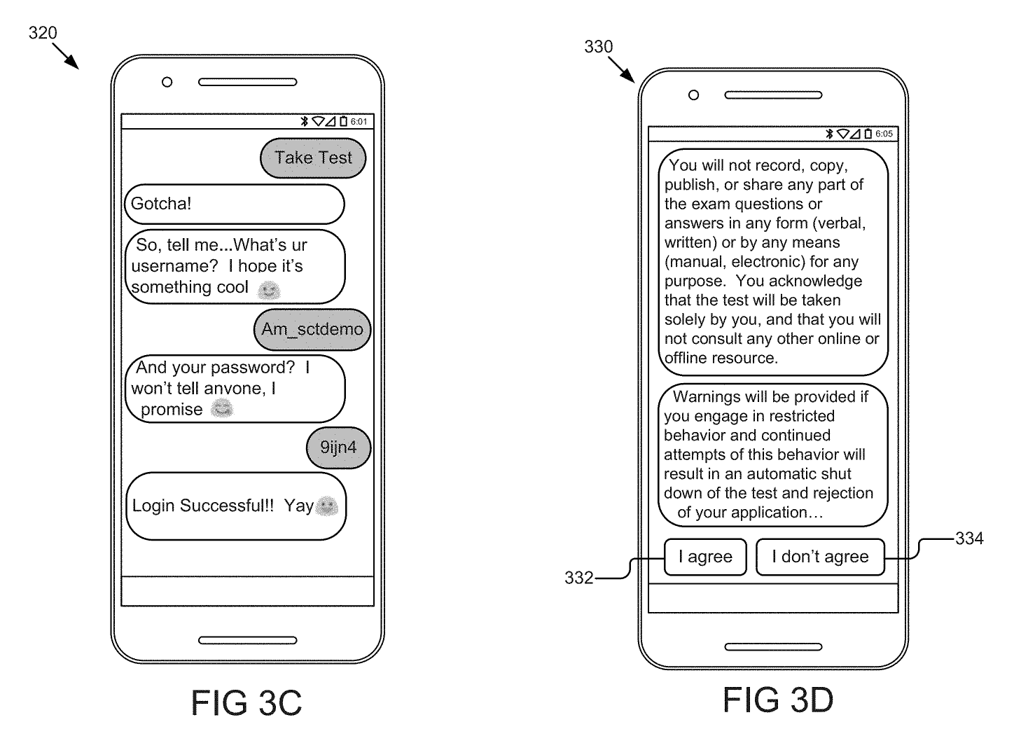

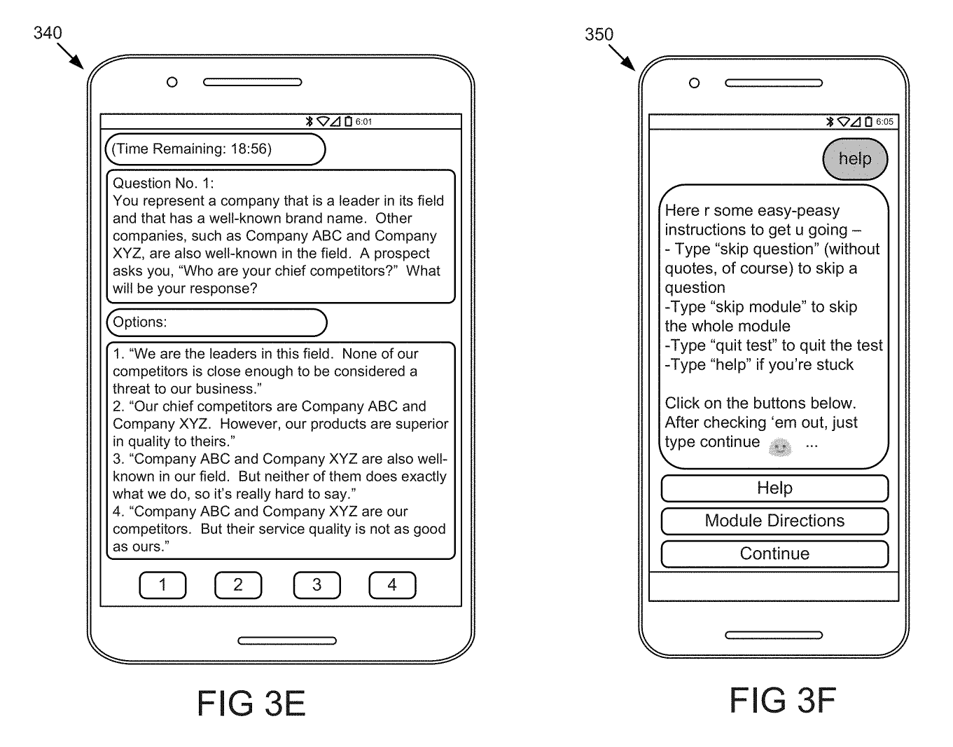

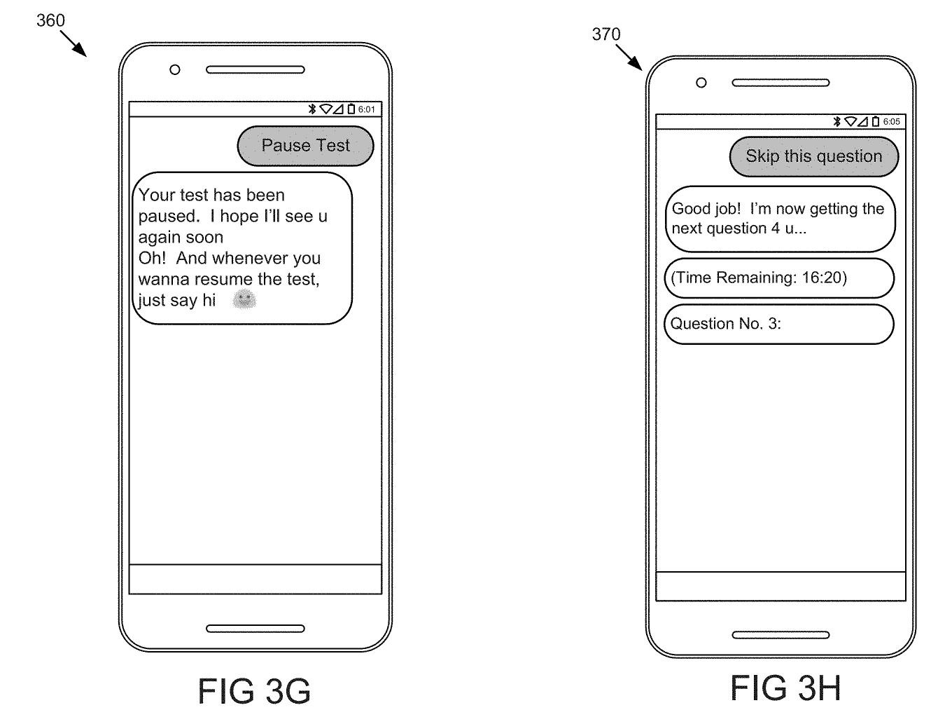

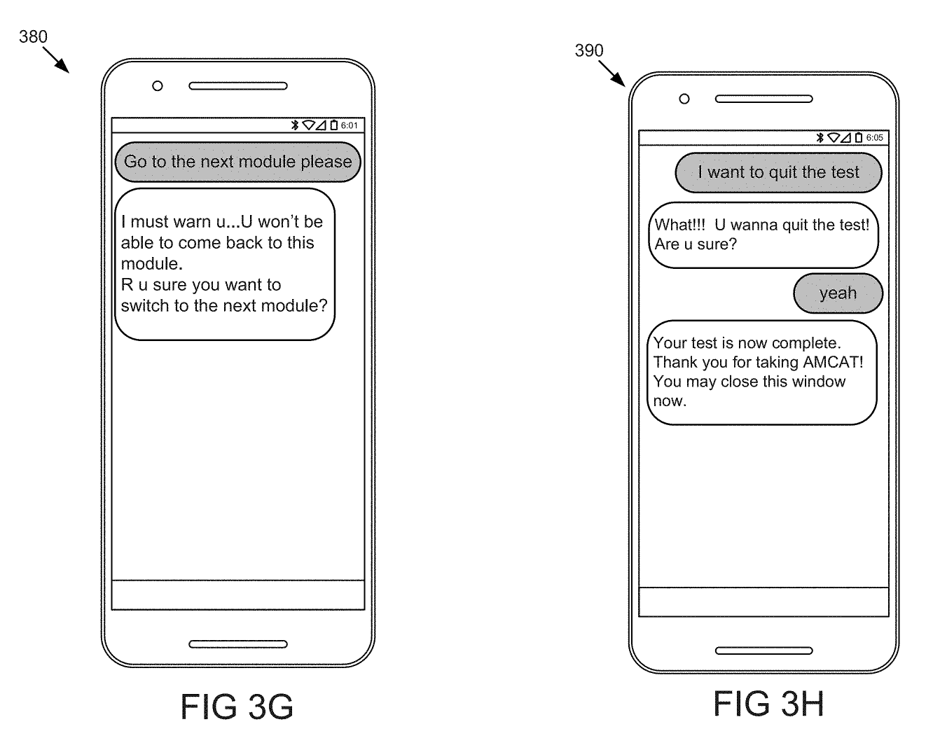

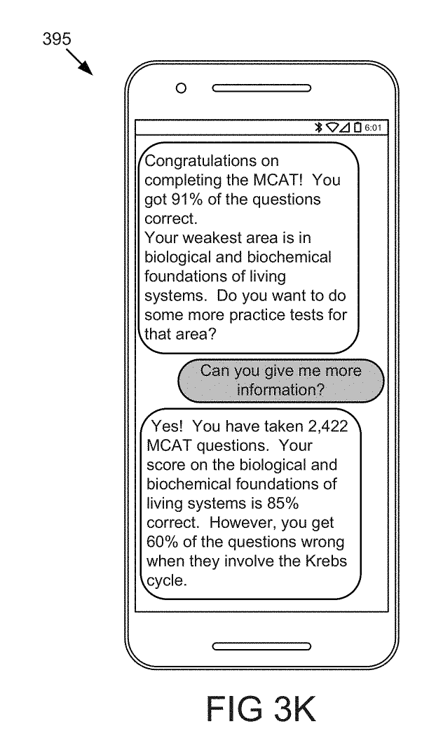

Turning to FIG. 3A, an example user interface 300 is illustrated of a messaging stream for an introduction sequence that includes an informal communication style. In this example, the messaging application 103 introduces itself with an informal communication style, such as “u” instead of “you” and emojis. In this example, the user responses with a similarly informal style by responding “I′m good! u?” The messaging module 202 determines that the user is comfortable with the messaging application 103 using the informal communication style and continues to use the same type of communication style.

The introduction sequence illustrated in FIG. 3A also includes an option to start a test. In some embodiments, if the user selects the “take test” button 305, the messaging module 202 translates the “take test” button into a “take test” introductory response that activates the test. The user may also enter text into the text field 306. For example, the messaging module 202 may provide answers to any clarifying questions. The user may also be able to start the test by typing “take test” into the text field 306. In some embodiments, the next sequence is an authentication sequence, which is described in greater detail below with reference to FIG. 3C.

FIG. 3B illustrates an example user interface 310 of a messaging stream for an introduction sequence that includes a formal communication style. In this example, the messaging module 202 provides the same informal communication style, but the user responds with “Hello Amchat, can we get started?” The messaging module 202 determines that because the user responded with proper punctuation, no abbreviations for words, and a desire to start the test instead of chit chat, the user prefers a formal communication style. As a result, instead of responding with “So, tell me . . . What do u wanna do today?” as the messaging module 202 responded in the informal communication style in FIG. 3A, the messaging module 202 responds with “Yes, of course! What would you like to do today?”

FIG. 3C illustrates an example user interface 320 of a messaging stream for an authentication sequence according to some embodiments. FIG. 3C is illustrated in the informal communication style. FIG. 3C may be a continuation of FIG. 3A after the user selects the “take a test” button 305 in FIG. 3A. In this example, the messaging module 202 asks the user to provide a username and password.

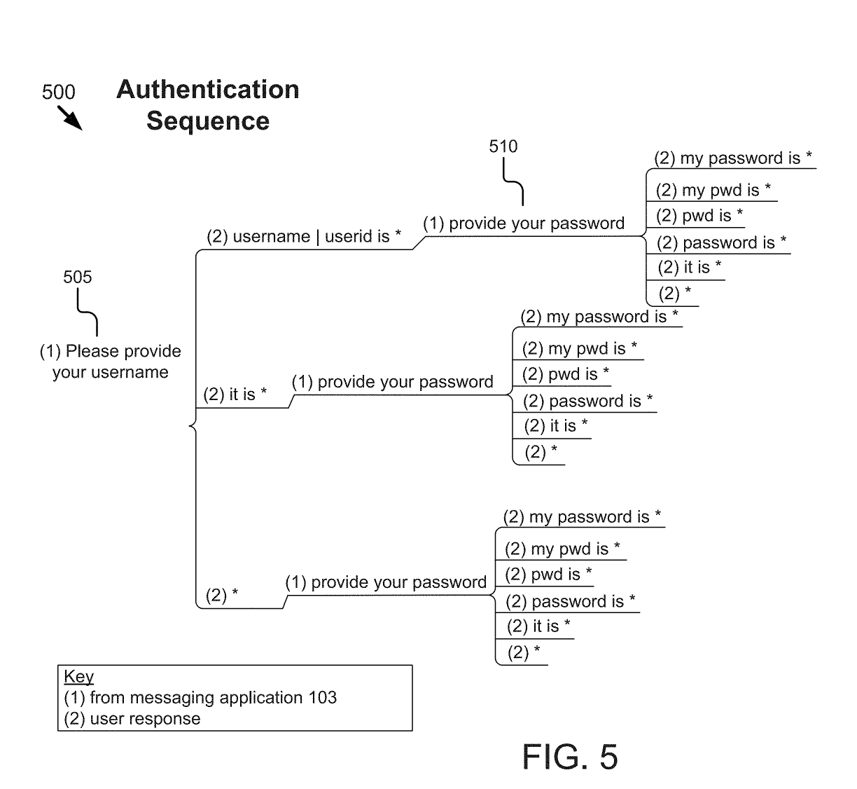

The messaging module 202 compares the authentication response that includes the username and the authentication response that includes the password and compares each of them to recognizable responses stored in a database 247. Examples of recognizable responses for authentication are described in further detail below with reference to FIG. 5. In this example, the username is a recognizable response because the user provided the password “Am_sctdemo.” Further, the password is a recognizable response because the user provided “9ijn4.”

FIG. 3D illustrates an example user interface 330 of a messaging stream for a disclaimer sequence according to some embodiments. FIG. 3D may be used in the informal communication style or a formal communication style. Because the disclaimer sequence is so important, it is written the same for all communication types. In some embodiments, the disclaimer sequence follows successful authentication. As a result, FIG. 3D may be the screen that follows FIG. 3C.

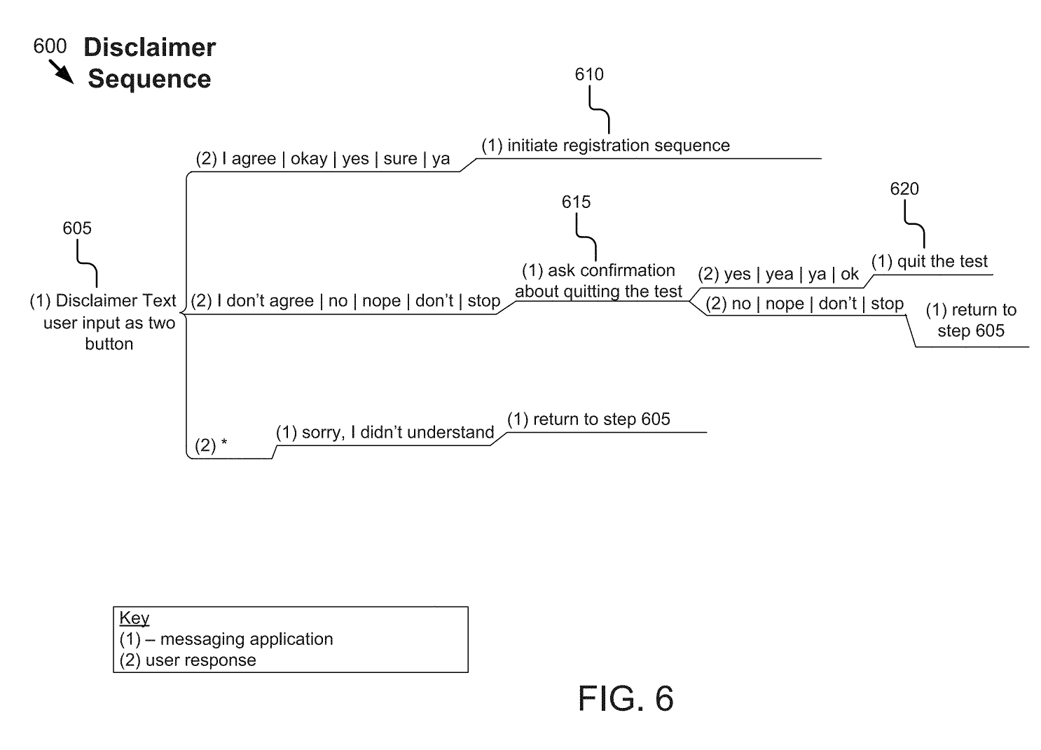

The messaging module 202 generates a disclaimer sequence that includes disclaimer language. The messaging module 202 may also provide an “I agree” button 332 and an “I don't agree” button 334. If the user selects the “I agree” button 332, the messaging module 202 may proceed with a registration sequence. If the user selects the “I don't agree” button 334, the messaging module 202 may prohibit the user from taking a test. Examples of disclaimer responses for the disclaimer sequence are described in further detail below with reference to FIG. 6.

If the user agrees to the disclaimer, the messaging module 202 causes the test to start. Other sequences, however, are possible. For example, after the disclaimer sequence, the messaging module 202 may activate a security questions sequence to establish security questions that the user has to answer to before the user has access to the test. Once the test begins, the messaging module 202 may start a timer, provide the user with a test identifier that may be used for future queries, display instructions for the test, and display the first question for the first module. In some embodiments, the messaging module 202 may instruct the user in different ways to answer the test. For example, the answers could be multiple choice or the user may be able to provide different ways to answer the question using natural language, such as “I think the answer is 3,” “I'm sure the answer is 3,” or “Maybe the answer is 2.” The messaging module 202 may also inform the user that the messaging application 103 is able to understand any way of answering the question in conversational English.

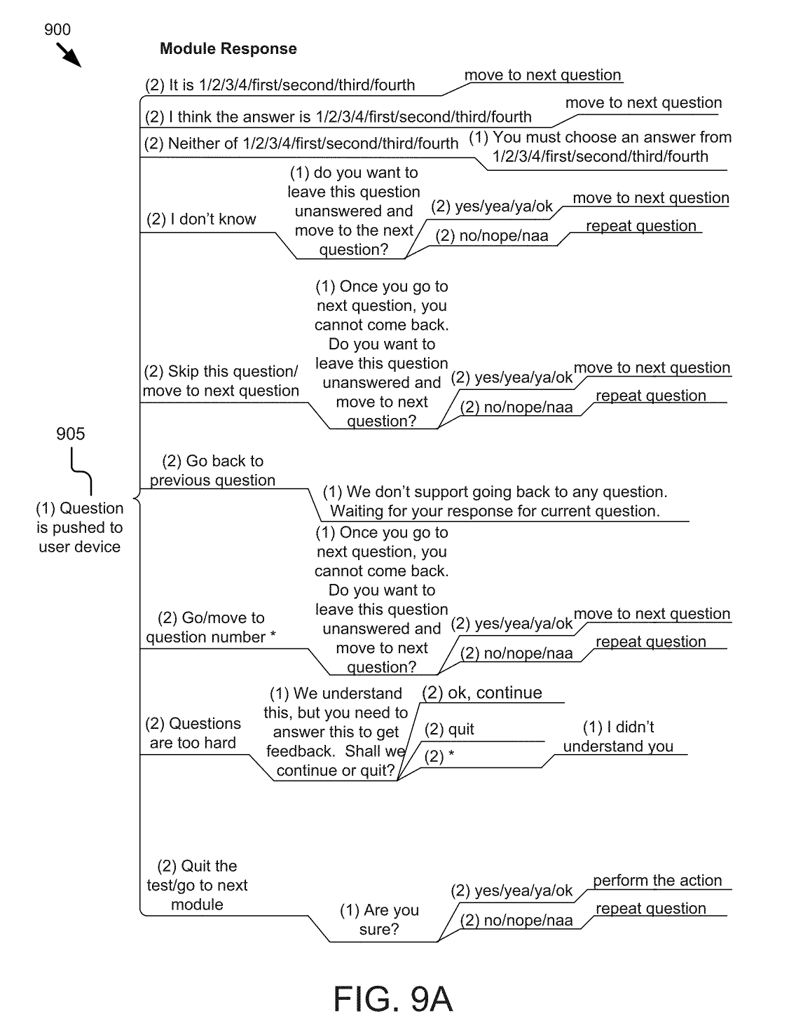

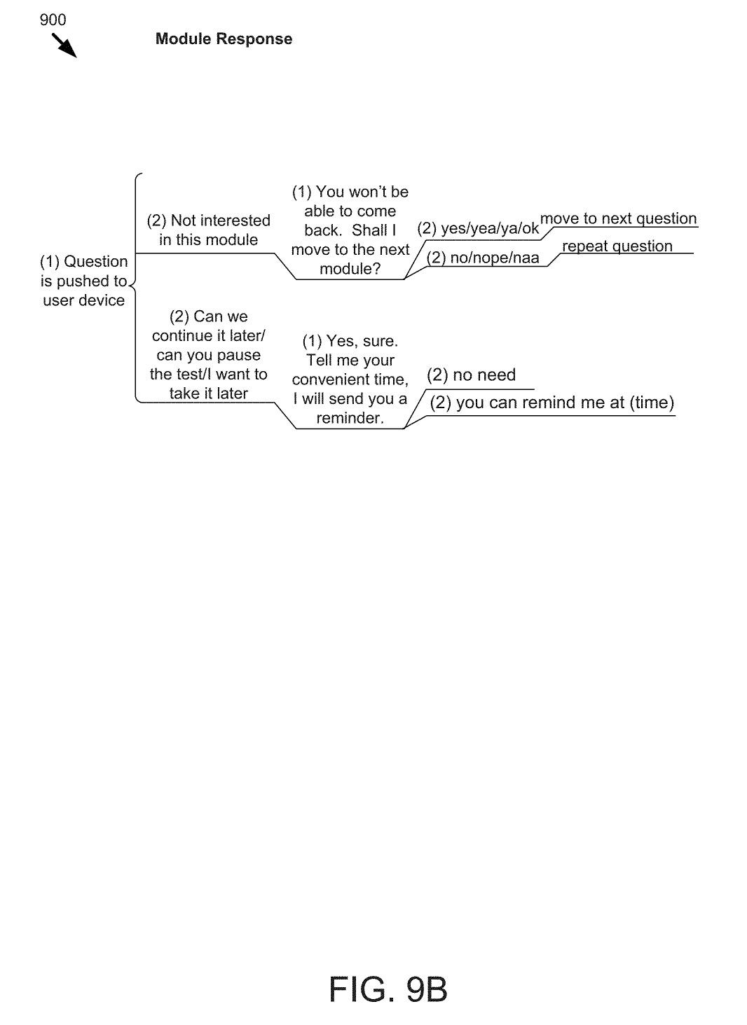

FIG. 3E illustrates an example user interface 340 of a messaging stream for a questions sequence for a first module according to some embodiments. In this example, the messaging module 202 presents questions and the user answers the questions. The question may be answered by selecting one of the numbered buttons at the bottom of the user interface. In other examples, the user interface may include a text field below the question for providing a first module response. Examples of recognizable responses for module responses (i.e., a user response related to a question) are described in further detail below with reference to FIGS. 9A-B.

FIG. 3F illustrates an example user interface of a messaging stream 350 with helpful commands. The messaging module 202 may provide a list of commands that the user can use in response to the user typing “help.” In this example, the list includes ways to skip a question, skip the module, quit the test, and get help. The user interface also includes buttons that the user can select to obtain help, module directions, or continue. Continue may include returning to the test.

FIG. 3G illustrates an example user interface 360 of a messaging stream for pausing the test according to some embodiments. At any point during the test, the messaging module 202 will pause the test responsive to receiving a request to pause, such as “I want to pause the test,” “Please pause the test,” or “Can you pause the test?” In embodiments where pausing the test may affect the user's score, the messaging module 202 may warn the user, such as by saying “If you pause this test, it will deduct 5 points from your score. Are you sure that you want to pause? Y/N.”

The messaging module 202 pauses the test and the user interface informs the user that the user can resume the test by saying “Hi.” In some embodiments, the messaging module 202 will then repeat the authentication sequent, the disclaimer sequent, and provide the user with the option to start test/resume test or choose to resume the test either by clicking on a button or stating the user's preference using conversational English.

FIG. 3H illustrates an example user interface 370 of a messaging stream for skipping a question according to some embodiments. In some embodiments, a user may be able to skip a current question during the test by typing “I want to skip the question,” “Please skip this question,” “Can you skip the question please?” or something similar. In this example, the user types “skip this question” and the messaging module 202 generated messages to explain that the messaging module 202 is retrieving the next question (for example, from the database 247), the time remaining to take the test, and information about the test. In this example, the messaging module 202 allows the user to skip the question and come back to the question later. In embodiments where navigation between questions is prohibited, the messaging module 202 may provide a warning after the user requests to skip the current question stating that the user is not able to return to the skipped question. The messaging module 202 may only provide this warning or other warnings a first time the situation arises and not for subsequent requests.

In some embodiments, the messaging module 202 allows a user to move to a subsequent question but prohibits going back to a previous question. This may depend on the type of test being taken. The messaging module 202 may recognize a request to go to the previous question, for example, by typing “I want to go to the previous question,” “Can you jump to the previous question please?” “Please move to the previous question,” or something similar. Depending on the rules of the test the messaging module 202 may instruct the user interface module 208 to display the previous question or display a message generated by the messaging module 202 that states something like “Sorry . . . U can't go back to any question. That's just not how it works [symbol] Plz answer the current question.”

FIG. 31 illustrates an example user interface 380 for moving to a next module according to some embodiments. The test may be divided into different groups of module questions. For example, if the test is the scholastic assessment (SAT), a first question module may include questions about math and a second question module may include questions about evidence-based reading and writing. In some embodiments, the messaging module 202 may allow a user to move to a different module of questions by typing “I want to go to the next module,” “Can you jump to the next module?” “Please move to the next module,” or something similar. In this example, the user types “go to the next module please” and the messaging module 202 instructs the user interface module 208 to generate the following message: “I must warn u . . . U won't be able to come back to this module. R u sure you want to switch to the next module?”

FIG. 3J illustrates an example user interface 390 of a messaging stream for quitting a test according to some embodiments. In some embodiments, the messaging module 202 recognizes a user's request to quit when the user types “I want to go quit,” “Please quit,” “Exit now” or something similar but asks for clarification about whether the user wants to quit the test or quit the module (if multiple modules are available).

In this example, the user types “I want to quit the test.” The messaging module 202 may provide a warning about how the user may not come back to the test. In examples where the user may return to the test, the messaging module 202 may instruct the user interface module 208 to provide a message asking for confirmation. If the user responds positively, the messaging module 202 may instruct the user interface module 208 to update the user interface to state that the user successfully quit the test.

FIG. 3K illustrates an example user interface 395 of a messaging stream that includes scores and recommendations about areas of improvement according to some embodiments. In this example, the user took the medical college admission test (MCAT). The scoring module 204 may determine a score based on individual scores generated by the messaging module 202 for each user response to a question.

The user interface module 208 generates a user interface that includes the score and a recommendation about areas of improvement. In this example, the user interface module 208 informs the user that the scored 91% on the MCAT and the user's weakest area was in the biological and biochemical foundations of living systems.

In some embodiments, the messaging module 202 interacts with the user to provide additional information responsive to a user request. In this example, the user asks “Can you give me more information?” The messaging module 202 instructs the user interface module 208 to respond: “Yes! You have taken 2,422 MCAT questions. Your score on the biological and biochemical foundations of living systems is 85% correct. However, you get 60% of the questions wrong when they involve the Krebs cycle.” Although not illustrated, the scoring module 204 may determine how best to improve the user's score and instruct the user interface module 208 to follow up with options for taking only questions on the Krebs cycle that are designed to improve the user's score in the user's weakest area.

### Example Methods

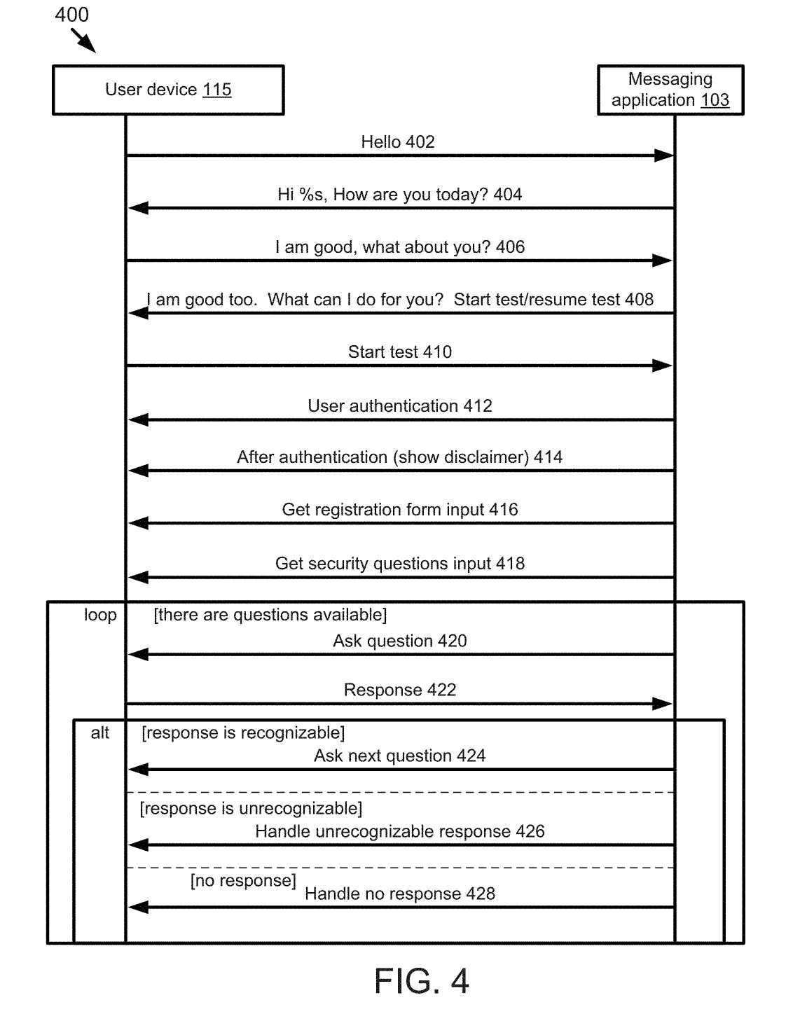

FIG. 4 illustrates a flowchart of an example overview method 400 of interactions between the messaging application 103 and a user device 115 according to some embodiments. The method 400 is performed by a messaging application 103 stored on a computing device 200 and a user device 115. In some embodiments, the messaging application 103 is stored on the user device 115.

At step 402, the user device 115 sends a message to the messaging application 103 with the word “Hello.” At step 404, the messaging application 103 generates a response message with the user's name (as indicated by “%s”) and responds “Hi %s, How are you today?” At step 406, the user device 115 response “I am good, what about you?” At step 408, the messaging application 103 responds, “I am good too. What can I do for you? Start test/resume test.” The start test/resume test may be displayed as buttons that the user may press to select to either start a test or resume a test. At step 410, the user response “Start test.”

At step 412, the messaging application 103 starts a user authentication sequence. For example, the messaging application 103 may use the authentication sequence discussed in greater detail below with reference to FIG. 5.

At step 414, once authentication has completed, the messaging application 103 starts a disclaimer sequence. For example, the messaging application 103 may use the disclaimer sequence discussed in greater detail below with reference to FIG. 6.

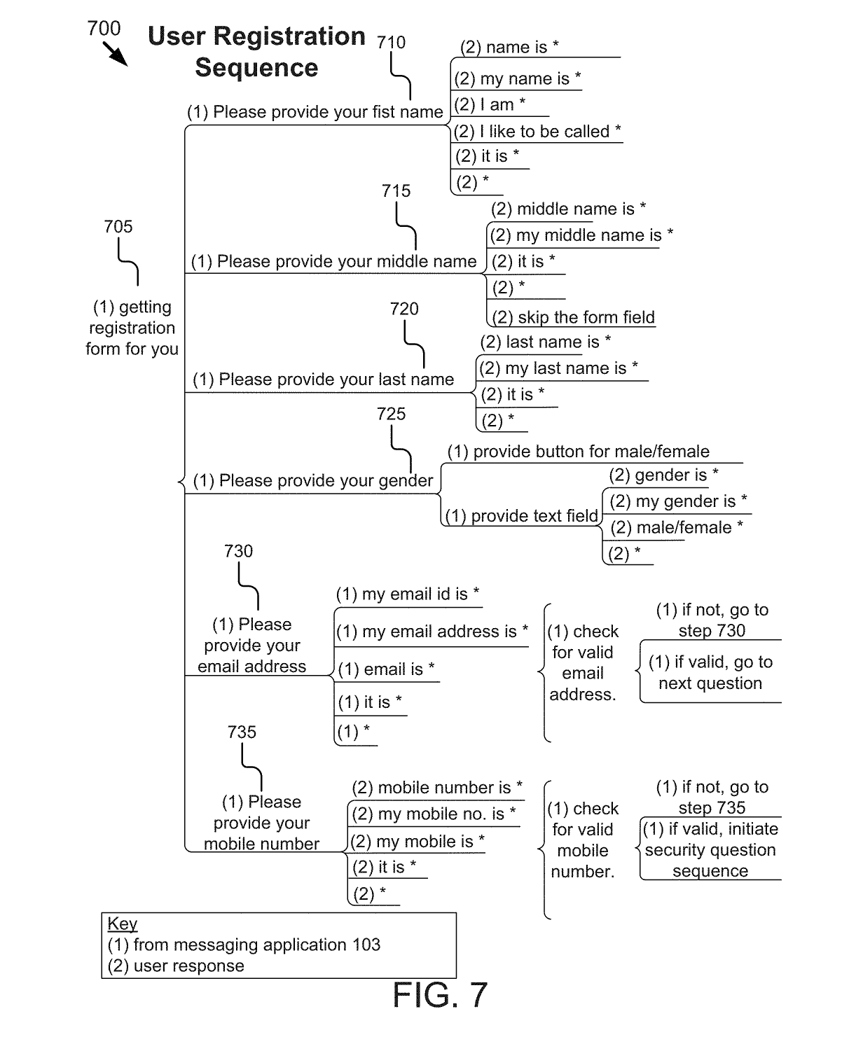

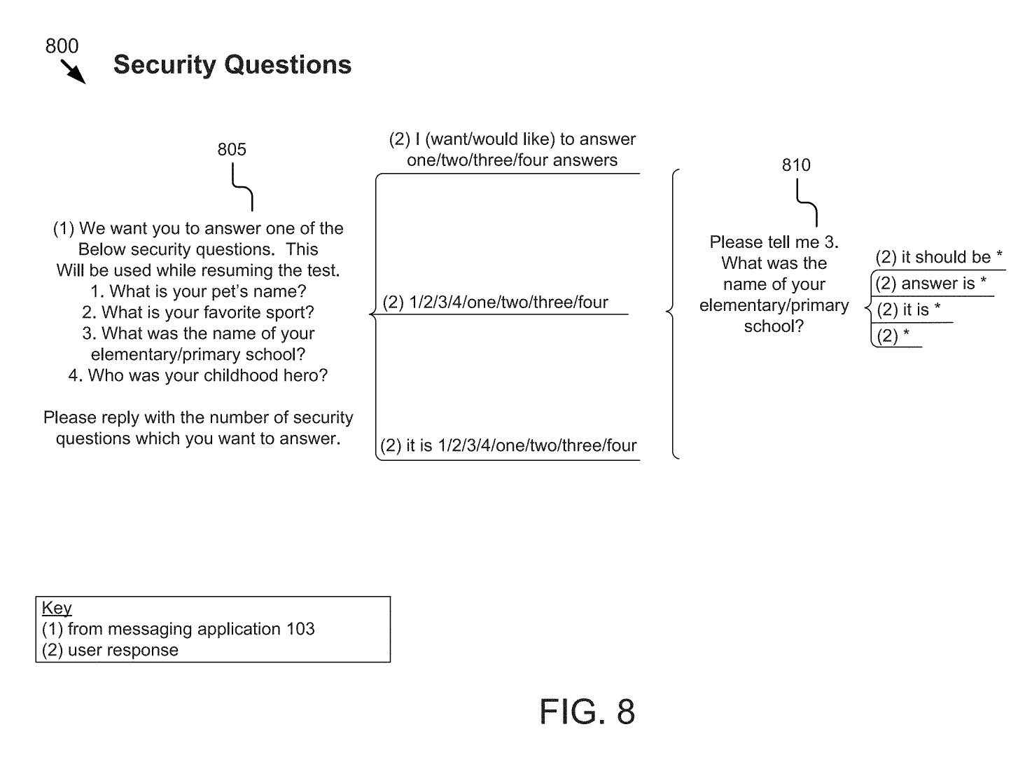

At step 416, the messaging application 103 starts a registration sequence by getting registration form input. For example, the messaging application 103 may use the registration sequence discussed in greater detail below with reference to FIG. 7.

At step 418, the messaging application 103 starts a security questions sequence. For example, the messaging application 103 may use the security questions sequence discussed in greater detail below with reference to FIG. 8.

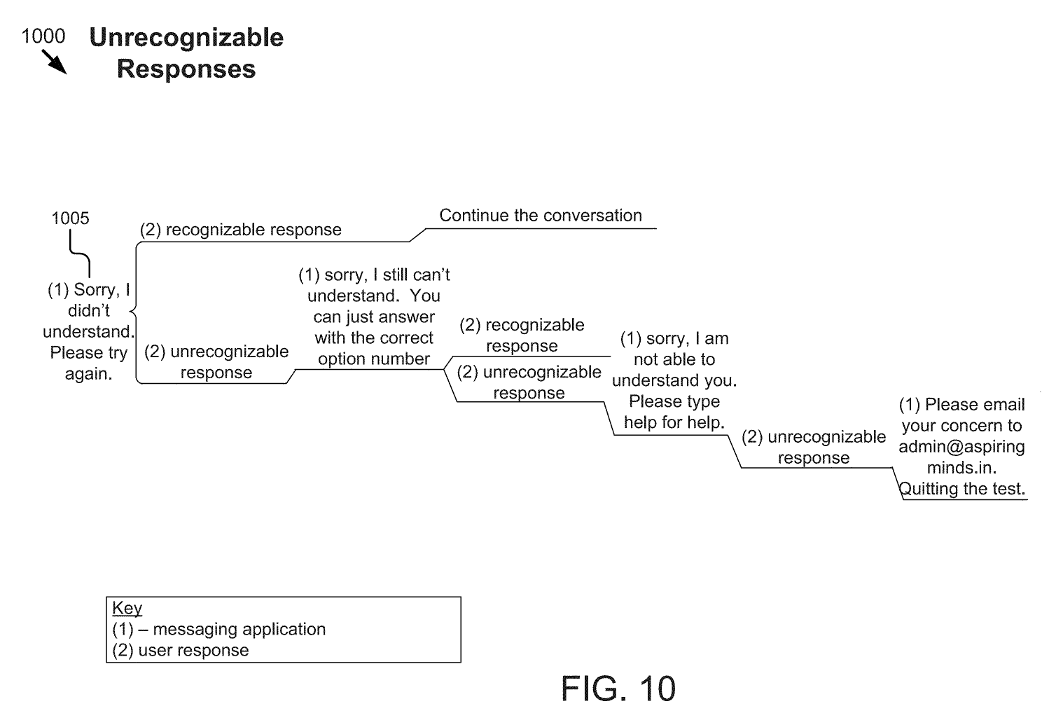

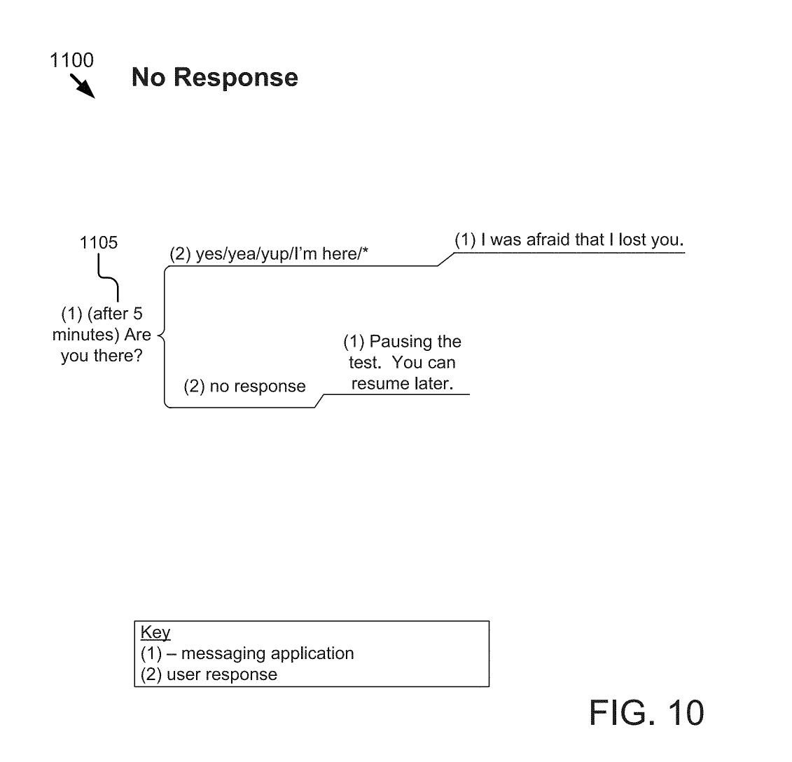

Steps 420-428 may include a loop for administering the question answering sequence as long as there are questions available. The messaging application 103 may exit the loop once all questions have been presented. Steps 424-428 may be a subroutine for handling user responses based on whether the user response is recognizable, unrecognizable, or nonresponsive. At step 420, the messaging application 103 answers a question. At step 422, the user device 115 provides a response (which may include a timeout after no response has been provided). If the response is recognizable, at step 424, a next question is asked. The question answering sequence is discussed in greater detail below with reference to FIGS. 9A-B. If the response is unrecognizable, at step 426, the unrecognizable response is handled. The unrecognizable response sequence is discussed in greater detail below with reference to FIG. 10. If no response is provided, at step 428 the no response is handled. The no response sequence is discussed in greater detail below with reference to FIG. 11.

The following flowcharts illustrate recognizable responses and actions that are organized as tree structures. The tree structures may be stored in the database 247. The actions may include, for example, a next question that is presented after a user response to a previous question.

FIG. 5 illustrates a flowchart of an example method 500 for an authentication sequence. The method 500 is performed by a messaging application 103 stored on a computing device 200, such as a messaging server 101 or a user device 115.

At step 505, the messaging application 103 asks the user to “Please provide your user name.” The messaging application 103 may recognize a variety of responses, such as “username” or “userid is *” where the * represents the username. The messaging application 103 also recognizes “it is *” or “*,” which represents the password itself. If the user response includes a recognizable response, at step 510 the messaging application 103 asks the user to “provide your password.” The messaging application 103 recognizes the following responses “my password is *,” “my pwd is *,” “pwd is *,” “password is *,” “it is *,” or “*.” Additional answers may be recognized. For example, the machine learning module 206 may continually updated a set of recognizable responses stored in the database 247 with additional examples.

FIG. 6 illustrates a flowchart of an example method 600 for a disclaimer sequence according to some embodiments. The method 600 is performed by a messaging application 103 stored on a computing device 200, such as a messaging server 101 or a user device 115.

At step 605, the messaging application 103 displays disclaimer text, such as the disclaimer text illustrated in FIG. 3D and provides an option for user input as two button. For example, the two buttons are “I agree” and “I disagree.” The messaging application 103 receives a response from the user either by the user selecting one of the buttons or providing text via a text field.

If the user responds with an affirmative answer, such as by using “I agree,” “okay,” “yes,” “sure,” “ya” or other affirmative statements, at step 610 the messaging application 103 initiates the registration sequence. If the user answers in the negative, such as by using “I don't agree,” “no,” “nope,” “don't,” “stop,” or other negative statements, at step 615 the messaging application 103 asks for confirmation about quitting the test. If the user responds with an affirmative answer, such as “yes,” “yea,” “ya,” “ok,” or other affirmative statements, at step 620 the messaging application 103 quits the test. If the user responds with a negative answer, such as “no,” “nope,” “don't,” “stop,” or other negative statements, the method 500 returns to step 605.

If the user responds to the disclaimer text with something other than an affirmative response or a negative response, at step 620 the messaging application 103 states “sorry, I didn't understand” and returns to step 605.

FIG. 7 illustrates a flowchart of an example method 700 for a user registration sequence according to some embodiments. The method 700 is performed by a messaging application 103 stored on a computing device 200, such as a messaging server 101 or a user device 115. The user registration sequence may start with a get registration form instruction.

At step 705, the messaging application 103 may provide the user with the message “getting registration form for you.”

At step 710, the messaging module 202 states “Please provide your first name.” A recognizable user response includes, for example, “name is *,” “my name is *,” “I am *,” “I like to be called *,” “it is *,” “*,” or a similar response.

At step 715, the messaging application 103 states “Please provide your middle name.” A recognizable user response includes, for example, “middle name is *,” “my middle name is *,” “it is *,” “*,” “skip the form field,” or a similar response. The middle name may be skipped because it is not essential to registration the same way that a first name or a last name is.

At step 720, the messaging application 103 states “Please provide your last name. A recognizable user response includes, for example, “last name is *,” “my last name is *,” “it is *,” “*,” or a similar response.

At step 725, the messaging application 103 states “Please provide your gender.” Other ways of phrasing this question may ask for an identifying gender, sex, or male and female buttons with text that states “which option describes you?” The messaging application 103 may also provide male and female buttons and receive a response form the user. If the messaging application 103 provides a text field, a recognizable user response includes, for example, “gender is *,” “my gender is *,” “male/female *,” “*,” or a similar response.

At step 730, the messaging application 103 states “Please provide your email address.” A recognizable user response includes, for example, “email id is *,” “my email address is *,” “email is *,” “it is *,” “*,” or a similar response. The messaging application 103 checks to see if the email address is valid. If the email address is not valid, the method 700 returns to step 730. In some embodiments, the messaging application 103 may state “That email address is not valid” and then returns to step 730. If the email address is valid, the messaging application 103 goes to the next question, which may be step 735.

At step 735, the messaging application 103 states “Please provide your mobile number.” A recognizable user response includes, for example, “mobile number is *,” “my mobile no. is *,” “it is *,” “*,” or a similar response. The messaging application 103 checks for a valid mobile number. If the mobile number is not valid, the method 700 returns to step 735. In some embodiments, the messaging application 103 may state “That mobile number is not valid” and then returns to step 735. If the email address is valid, the messaging application 103 initiates the security question sequence.

FIG. 8 illustrates a flowchart of an example method 800 for a security questions sequence according to some embodiments. The method 800 is performed by a messaging application 103 stored on a computing device 200, such as a messaging server 101 or a user device 115.

At step 805, the messaging application 103 provides a list of security questions and asks the user to replay with the number of security questions the user wants to answer.

If the user responds with recognizable answers that include “I (want/would like) to answer one/two/three/four answers,” “1/2/3/4/one/two/three/four,” “1/2/3/4/one/two/three/four,”or something similar, at step 810 the messaging application 103 provides one of the security questions and answers for a response. The messaging application recognizes “it should be *,” “answer is *,” “it is *,” “*,” or something similar as an answer.

FIGS. 9A-B illustrates a flowchart of an example method 900 for a questions sequence according to some embodiments. Once the messaging application 103 begins the test, the messaging application 103 provides instructions, such as “Submitting registration form to AM server . . . Starting the test for you . . . Your AMcatid is 30001814873273. Please save it for future queries. You are required to solve 14 questions in 14 minutes.” At step 905, the question is pushed to the user device 115.

The user may respond “It is 1/2/3/4/first/second/third/fourth” or “I think the answer is 1/2/3/4/first/second/third/fourth” and the messaging application 103 will move to the next question. The messaging module 103 may also score the response based on the accuracy and the confidence of the answer. If the user responses “Neither of 1/2/3/4/fist/second/third/fourth,” the messaging application 103 responds “You must choose an answer from 1/2/3/4/first/second/third/fourth.” The messaging application 103 may repeat this sequence three times and, if the user continues to say “I don't know,” in some embodiments the messaging application 103 quits after three tries. If the user responds “Skip this question/move to next question,” the messaging application 103 responds “Once you go to next question, you cannot come back. Do you want to leave this question unanswered and move to next question?” If the user answers affirmatively with an answer such as “yes/yea/ya/ok,” the messaging application 103 moves to the next question. If the user answers negatively with an answer such as “no/nope/naa,” the messaging application 103 repeats the question. If the user responds “Go back to previous question,” the messaging application 103 may respond “We don't support going back to any question. Waiting for your response for current question.” If the user responds “Go/move to question number *,” the messaging module 103 responds “Once you go to next question, you cannot come back. Do you want to leave this question unanswered and move to next question?” If the user answers affirmatively with an answer such as “yes/yea/ya/ok,” the messaging application 103 moves to the next question. If the user answers negatively with an answer such as “no/nope/naa,” the messaging application 103 repeats the question. If the user responds “Questions are too hard,” the messaging application 103 may respond “We understand this, but you need to answer this to get feedback. Shall we quit?” The user may respond “ok, continue” or “quit.” If the user provides a different answer, the messaging application 103 may respond “I didn't understand you.” If the user responds “Quit the test/go to next module,” the messaging application 103 may respond “Are you sure?” If the user answers affirmatively with an answer such as “yes/yea/ya/ok,” the messaging application 103 performs the action. If the user answers negatively with an answer such as “no/nope/naa,” the messaging application 103 repeats the question. If the user responds “Not interested in this module,” the messaging application 103 responds “You won't be able to come back. Shall I move to the next module?” If the user answers affirmatively with an answer such as “yes/yea/ya/ok,” the messaging application 103 moves to the next question. If the user answers negatively with an answer such as “no/nope/naa,” the messaging application 103 repeats the question. If the user responds “Can we continue it later/can you pause the test/I want to take it later,” the messaging application 103 responds “Yes, sure. tell me your convenient time, I will send you a reminder.” The user may answer “no need” or “you can remind me at (time).”

FIG. 10 illustrates a flowchart of an example method 1000 for unrecognizable responses sequence according to some embodiments. If the user provides unrecognizable data, at step 1005, the messaging application 103 states “Sorry, I didn't understand. Please try again.” If the response is recognizable, the conversation is continued. If the response is unrecognizable, the messaging application 103 responds “Sorry, I still can't understand. You can just answer with the correction option number.” If the user provides a recognizable response, the conversation continues. If the user provides an unrecognizable respond, the messaging application 103 responds “sorry, I am not able to understand you. Please type help for help.” If the user provides an unrecognizable response, the messaging application 103 responds “Please email your concern to admin@ aspiringminds.in. Quitting the test.”

FIG. 11 illustrates a flowchart of an example method 1100 for a no response sequence according to some embodiments. If the user has not responded for five minutes (or another predetermined amount of time,” at step 1105, the messaging application 103 responds “Are you there?” If the user responds “yes/yea/yup/I′m here/*,” the messaging application 103 responds “I was afraid that I lose you.” and continues with the test. If there is no response, after a predetermined amount of time, the messaging application 103 states “Pausing the test. You can resume the test later.” and pauses the test.

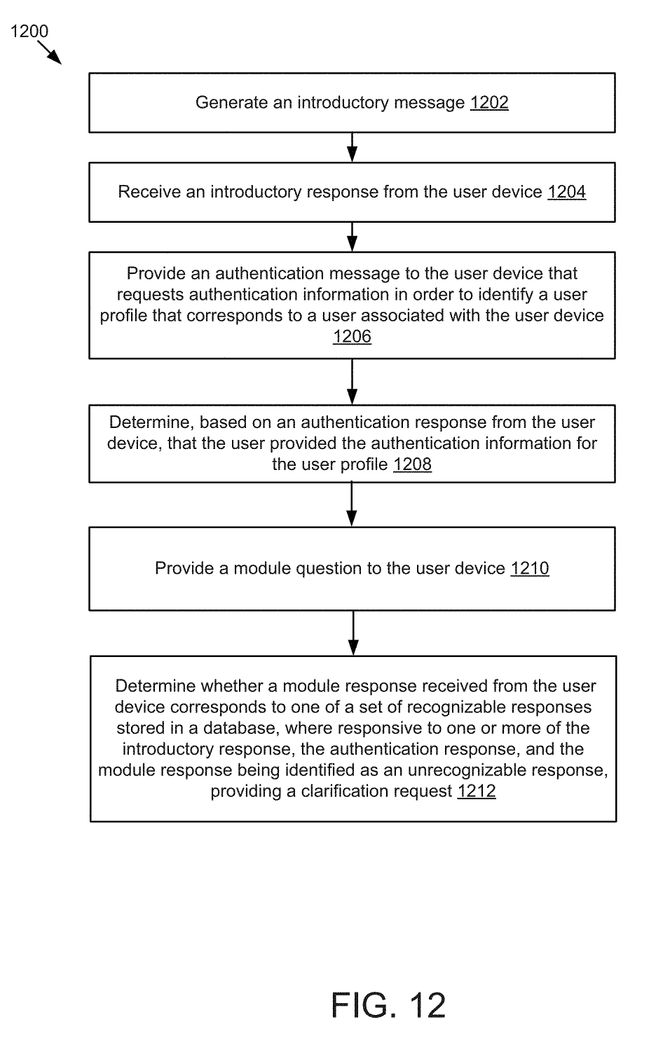

FIG. 12 illustrates a flowchart of an example method 1200 for generating a messaging stream according to some embodiments. The method 1200 is performed by a messaging application 103 stored on a computing device 200, such as a messaging server 101 or a user device 115.

At step 1202, an introductory message is generated, such as the introductory messages illustrated in FIGS. 3A and 3B. At step 1204, an introductory response is received from the user device 115. At step 1206, an authentication message is provided to the user device 115 that requests authentication information in order to identify a user profile that corresponds to a user associated with the user device. At step 1208, it is determined, based on an authentication response from the user device, that the user provided the authentication information for the user profile. At step 1210, a module question is provided to the user device 115. At step 1212, it is determined whether a module response received from the user device corresponds to one of a set of recognizable responses stored in a database 247, where responsive to one or more of the introductory response, the authentication response, and the module response being identified as an unrecognizable response, providing a clarification request.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMs, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

In situations in which the systems discussed above collect or use personal information, the systems provide users with an opportunity to control whether programs or features collect user information (e.g., information about a user's social network, social actions or activities, profession, a user's preferences, or a user'current location), or control whether and/or how to receive content from the server that may be more relevant o the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the server.

What is claimed is:

1. A computer-implemented method for generating a messaging stream that is transmitted over a network to a user device, the method comprising:
generating an introductory message;
receiving an introductory response from the user device;
providing a first module question to the user device;
determining whether a first module response that includes one or more words received from the user corresponds to one of a set of recognizable responses stored in a database;
scoring the first module responses; and
generating a user interface that includes a score of the user responses;
wherein responsive to one or more of the introductory response and the first module response being identified as an unrecognizable response, providing a clarification request.

2. The method of claim 1, further comprising:
determining a user preference for a type of communication based on one or more of the introductory response, the authentication response, and the first module responses; and
configuring the first module questions based on the user preference for the type of communication.

3. The method of claim 1, wherein the unrecognizable response is identified by using a machine-learning model that is trained to categorize user responses as one of the recognizable responses or the unrecognizable response, wherein the machine-learning model is trained on prior user responses.

4. The method of claim 3, further comprising:
receiving feedback to reclassify a first module response that was classified as the unrecognizable response to be one of the recognizable responses; and
modifying the recognizable responses based on the feedback.

5. The method of claim 1, further comprising:
providing an authentication message to the user device that requests authentication information in order to identify a user profile that corresponds to a user associated with the user device; and
determining, based on an authentication response from the user device, that the user provided the authentication information for the user profile.

6. The method of claim 5, wherein the first module questions correspond to a test and the user interface further includes recommendations about areas of improvement that are designed to help the user improve performance on the test.

7. The method of claim 5, wherein the first module responses are scored based on a confidence associated with each of the first module responses.

8. The method of claim 1, wherein the set of recognizable responses and actions based on the set of recognizable responses in the database are organized as a tree structure.

9. The method of claim 1, further comprising:
receiving a request from the user to exit the first module; and
responsive to receiving the request, providing second module questions to the user.

10. A non-transitory computer readable medium for generating a messaging stream that is transmitted over a network to a user device with instructions stored thereon that, when executed by one or more computers, cause the one or more computers to perform operations, the operations comprising:
generating an introductory message;
receiving an introductory response from the user device;
providing a first module question to the user device;
determining whether a first module response received from the user corresponds to one of a set of recognizable responses stored in a database;
scoring the first module responses; and
generating a user interface that includes a score of the user responses;
wherein responsive to one or more of the introductory response and the first module response being identified as an unrecognizable response, providing a clarification request.

11. The computer storage medium of claim 10, wherein the operations further comprise:
determining a user preference for a type of communication based on one or more of the introductory response, the authentication response, and the first module responses; and
configuring the first module questions based on the user preference for the type of communication.

12. The computer storage medium of claim 10, wherein the unrecognizable response is identified by using machine-learning model that is trained to categorize user responses as one of the recognizable responses or the unrecognizable response, wherein the machine-learning model is trained on prior user responses.

13. The computer storage medium of claim 12, wherein the operations further comprise:
receiving feedback to reclassify a first module response that was classified as the unrecognizable response to be one of the recognizable responses; and
modifying the recognizable responses based on the feedback.

14. The computer storage medium of claim 10, wherein the operations further comprise:
providing an authentication message to the user device that requests authentication information in order to identify a user profile that corresponds to a user associated with the user device; and
determining, based on an authentication response from the user device, that the user provided the authentication information for the user profile.

15. The computer storage medium of claim 10, wherein the first module questions correspond to a test and the user interface further includes recommendations about areas of improvement that are designed to help the user improve performance on the test.

16. A system for generating a messaging stream that is transmitted over a network to a user device, the system comprising:
one or more processors; and
a memory that stores instructions executed by the one or more processors, the instructions comprising:
generating an introductory message;
receiving an introductory response from the user device;
determining whether a first module response received from the user corresponds to one of a set of recognizable responses stored in a database;
scoring the first module responses; and
generating a user interface that includes a score of the user responses;
wherein responsive to one or more of the introductory response and the first module response being identified as an unrecognizable response, providing a clarification request.

17. The system of claim 16, wherein receiving the instructions further comprise:
determining a user preference for a type of communication based on one or more of the introductory response, the authentication response, and the first module responses; and
configuring the first module questions based on the user preference for the type of communication.

18. The system of claim 16, wherein the unrecognizable response is identified by using machine-learning model that is trained to categorize user responses as one of the recognizable responses or the unrecognizable response, wherein the machine-learning model is trained on prior user responses.

19. The system of claim 18, wherein the instructions further comprise:
receiving feedback to reclassify a first module response that was classified as the unrecognizable response to be one of the recognizable responses; and
modifying the recognizable responses based on the feedback.

20. The system of claim 16, wherein the instructions further comprise:
providing an authentication message to the user device that requests authentication information in order to identify a user profile that corresponds to a user associated with the user device; and
determining, based on an authentication response from the user device, that the user provided the authentication information for the user profile.
